(19) United States
(12) Patent Application Publication
(10) Pub. No.: US 2023/0051430 A1
(43) Pub. Date: Feb. 16, 2023

(54) MOBILE LEADERBOARD

(71) Applicant: IGT, Las Vegas, NV (US)

(72) Inventor: Ethan Edsall, Sparks, NV (US)

(21) Appl. No.: 17/399,373

(22) Filed: Aug. 11, 2021

(51) Int. Cl. G07F 17/32; G07F 17/34

(52) U.S. Cl. CPC G07F 17/3237; G07F 17/34; G07F 17/3272

(57) ABSTRACT

Embodiments described herein are directed to providing various types of leaderboards related to electronic games available in a gaming venue. These rank-ordered lists can be based on previous game play by a particular player or group of players and provided to a player’s mobile device. However, rather than being based on a single metric or aspect of a particular game, such as a score or an amount of winnings, leaderboards as disclosed herein can be related to a number of different aspects of any one or more electronic games. These aspects can include, but are not limited to, an amount of time played, an amount of wagers made, an amount of winnings, etc. Additionally, or alternatively, leaderboards can be generated showing and ranking various players for each such aspect.

### BACKGROUND

The present disclosure is generally directed to managing information related to a player of an electronic game and, more particularly, to providing various types of leaderboards related to electronic games available in a gaming venue.

In a gaming venue, such as a casino, some games are typically played by groups of players. For example, poker, blackjack, and roulette, are usually played by more than one person at a time. However, other games, such as slots, for example, are played individually, in a solitary manner. While players in groups may be able to know how they compare to each other, players of individual or solitary games typically have no idea how other players of such games are doing or how they compare to those players, e.g., in terms of winnings or any other game aspect. Some games may be organized into tournaments and, in such tournaments, players may be ranked based on the results of their game play. However, such rankings, often presented in a leaderboard, are based on a single factor, often amount of winnings. Currently, there are no such leaderboards for players of individual games, such as slots, for example. Similarly, there are no leaderboards or other ways for players to compare other aspects of games such as amount of time played, an amount of wagers placed, etc. between players or even by a single player tracked across different games.

### BRIEF SUMMARY

In certain embodiments, the present disclosure relates to a player information management system of a gaming venue comprising a repository storing an electronic file for a player. The electronic file can comprise a plurality of electronic records, the plurality of electronic records can comprise a record related to a game on an Electronic Gaming Machine (EGM) of the gaming venue, and each record of the plurality of records can comprise a field related to an aspect of the game on the EGM. The player information management system can further comprise a processor communicatively coupled with the repository and a memory coupled with and readable by the processor. The memory can store therein a set of instructions which, when executed by the processor, causes the processor to receive, from the EGM, an electronic message indicating initiation of play of a game on the EGM by a player, receive, from the EGM, electronic information defining a value for the aspect of the game on the EGM during individual play of the game on the EGM by the player, and record the value for the aspect of the game on the EGM defined in the received information in the field related to the aspect of the game on the EGM in the electronic record associated with the game in electronic file for the player. The instructions can further cause the processor to generate a rank-ordered list related to the aspect of the game on the EGM from the plurality of records and based on the field related to the aspect of the game in the electronic file for the player and provide the generated rank-ordered list to an electronic device associated with the player.

Additional features and advantages are described herein and will be apparent from the following Description and the figures.

### BRIEF DESCRIPTION OF THE SEVERAL VIEWS OF THE DRAWINGS

FIG. 1 is a block diagram illustrating elements of a gaming environment in which various embodiments of the present disclosure may be implemented.

FIG. 2 is a block diagram illustrating additional details of an exemplary player information management system according to one embodiment of the present disclosure.

FIG. 3 is a block diagram illustrating additional details of an exemplary mobile device according to one embodiment of the present disclosure.

FIG. 4 is a flowchart illustrating an exemplary process for providing rank-ordered lists according to one embodiment of the present disclosure.

FIG. 5 is a flowchart illustrating an exemplary process for presenting rank-ordered lists according to one embodiment of the present disclosure.

### DETAILED DESCRIPTION

Embodiments described herein are directed to providing various types of leaderboards related to electronic games available in a gaming venue. As used herein, the term leaderboard refers to a rank-ordered list of games, players and/or aspects of one or more games. These rank-ordered lists can be based on previous game play by a particular player or group of players and provided to a player’s mobile device. However, rather than being based on a single metric or aspect of a particular game, such as a score or an amount of winnings, leaderboards as disclosed herein can be related to a number of different aspects of any one or more electronic games for a player or group of players. These aspects can include, but are not limited to, an amount of time played, an amount of wagers made, an amount of winnings, etc. For example, leaderboards can be generated for listing a player’s favorite games based on an amount of time spent playing various games or game themes, the amount of money wagered on various games or game themes, the amount of winnings from various games or game themes, etc. Additionally, or alternatively, leaderboards can be generated showing and ranking various players for each such aspect. For example, a leaderboard can be generated showing which players have spent the most time playing a particular game or game theme, who has wagered the most on a various game or game theme, etc.

Such leaderboards are thought to increase a player’s engagement and thus encourage further game play. This is particularly true for games that are typically played individually or in a solitary manner such as slots, for example. While a player may have some intuitive idea, the individual player may be interested to know exactly how much time they spend on different games or game themes, for example. Typically, players of individual games such as slots, video poker, etc. have no idea how they may compare to other players in regard to amount of time played, amount of wagers place, amount of winnings, etc. Accordingly, leaderboards for such game aspects provided in a convenient manner, e.g., presented on the players mobile device, can increase interest and engagement in such games.

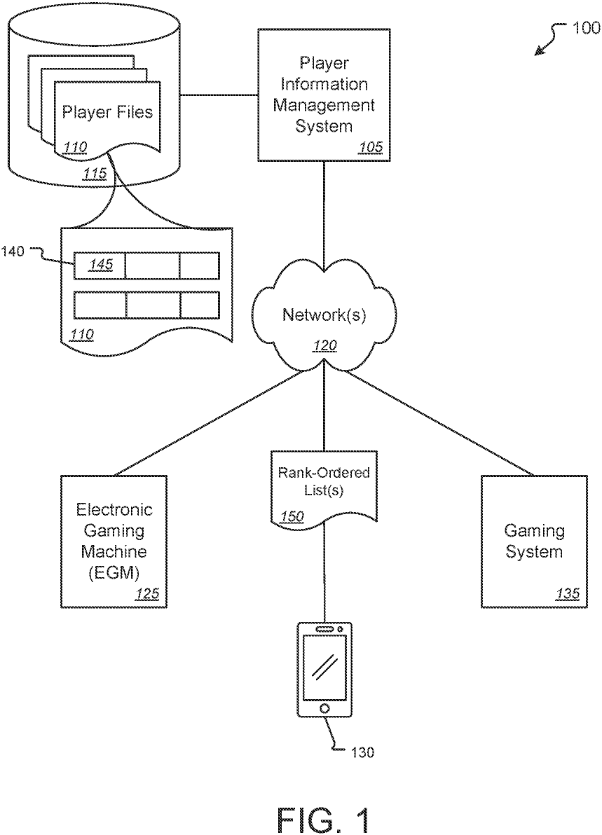

FIG. 1 is a block diagram illustrating elements of a gaming environment in which various embodiments of the present disclosure may be implemented. As illustrated in this example, the environment 100 can include a player information management system 105 which can be implemented on one or more servers and/or other computing devices on-premise, within the gaming venue, or remotely, as a cloud-based system. The player information management system 105 can maintain a set of player files 110 in a database or other repository 115. The player files 110 can comprise, for example, files associated with one or more known players of games within the gaming venue such as members of a loyalty program or other players who have registered for certain services of the gaming venue.

The player information management system 105 can be communicatively coupled with one or more local and/or wide area wired and/or wireless communications networks 120. The environment 100 can also include one or more Electronic Gaming Machines (EGMs) 125, mobile devices 130, and gaming systems 135 also communicatively coupled with the network(s) 120. Generally speaking and as used herein, the term EGM refers to any suitable electronic gaming machine which enables a player to play a game (including but not limited to a game of chance, a game of skill, and/or a game of partial skill) to potentially win one or more awards, wherein the EGM 125 comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk. The term gaming system generally refers to any type of computing device used to access or provide electronic games or gaming services of the gaming venue. The mobile devices 130 can comprise any type of wireless computing device including, but not limited to, cellphones, tablets, laptop computers, etc. as may be carries and used by players within the gaming venue.

Embodiments of the present disclosure are directed to providing various types of leaderboards related to electronic games available on the EGM(s) 125 and/or gaming systems 135 of the gaming venue. As used herein, the term leaderboard refers to a rank-ordered list of games, players and/or aspects of one or more games. These rank-ordered lists can be generated by the player information management system 105 based on the player files 110 and provided to a player’s mobile device 130 via the network(s) 120 of the gaming venue in response to a request by the player or when the player accesses a game of the gaming venue, e.g., by using a loyalty program app or mobile wallet app installed on the mobile device 130 to “card in” to the EGM 125 or gaming system 135.

Rather than being based on a single metric or aspect of a particular game, leaderboards as disclosed herein can be related to a number of different aspects of any one or more electronic games. These aspects can include, but are not limited to, an amount of time played, an amount of wagers made, an amount of winnings, etc. Accordingly, leaderboards can be generated for listing a player’s favorite games based on an amount of time spent playing various games or game themes, the amount of money wagered on various games or game themes, the amount of winnings from various games or game themes, etc. Additionally, or alternatively, leaderboards can be generated showing and ranking various players for each such aspect. For example, a leaderboard can be generated showing which players have spent the most time playing a particular game or game theme, who has wagered the most one a various game or game theme, etc.

More specifically, each of the player files 110 maintained by the player information management system 105 can comprise a plurality of records 140. Each record 140 can be related to a different one of the plurality of electronic games provided by the EGM(s) 125 and/or gaming system(s) 135 and can comprise a plurality of fields 145. Each field 145 on the plurality of fields can relate to a different aspect of the related electronic game and can have a value based on past play of the related electronic game by the player associated with the file 110. In other words, the files 110 can include files for any number of players and for each player, the associated file can include records associated with any number of different games and having fields for any number of different aspects of that game.

Once a player initiates game play on an EGM 125 or other gaming system 135, electronic information defining a value for the aspect of the initiated game can be received by the player information management system 105 during play of the game by the player and a value for the aspect of the game defined in the received information can be recorded in a field 145 related to the aspect of the game in the electronic record 140 associated with the game in the file 110 for the player. In this way, the record 140 for the game in the file 110 for the player can be updated based on game play by the player.

At some point in time, the player information management system 105 of the gaming venue can receive, from the mobile device 130 of the player, a request for information related to one or more games. In response, the player information management system 105 can generate one or more rank-ordered lists representing a leaderboard for the game or games based on the plurality of files 110. For example, the rank-ordered list can be related to a particular aspect of a game, e.g., amount of time played, winnings, etc. In such cases, the rank-ordered list can be ordered based on the value of a selected aspect, i.e., filed 145, of the plurality of aspects represented in the records 140 of the plurality of files 110, e.g., showing the players favorite or most winning games, in order. In other cases, the rank-ordered list may comprise a list of other players ranked by the selected aspect. In any such case, the player information management system 105 can provide the generated rank-ordered list(s) 150 to the mobile device 130 of the player in response to the request for information related to the game.

In some cases, the player information management system 105 can receive, from the mobile device 130 of the player, a request for additional information related to a game aspect represented in the provided rank-ordered list 150. In response, the player information management system 105 can provide, to the mobile device 130 of the player, the requested additional information. For example, the aspect may represent a game theme and the request for additional information can be initiated by a selection of a game theme of a rank-ordered list 150 of game themes provided to the player. In such cases, providing the additional information can comprise, for example, providing, by the player information management system 110, to the mobile device 130 of the player an indication of a location of a gaming machine in the gaming venue having the selected game theme. In other cases, the requested and provided additional information can relate to other aspects such as types of games, winningest games, longest played games, locations for such games, recommendations for other games, etc.

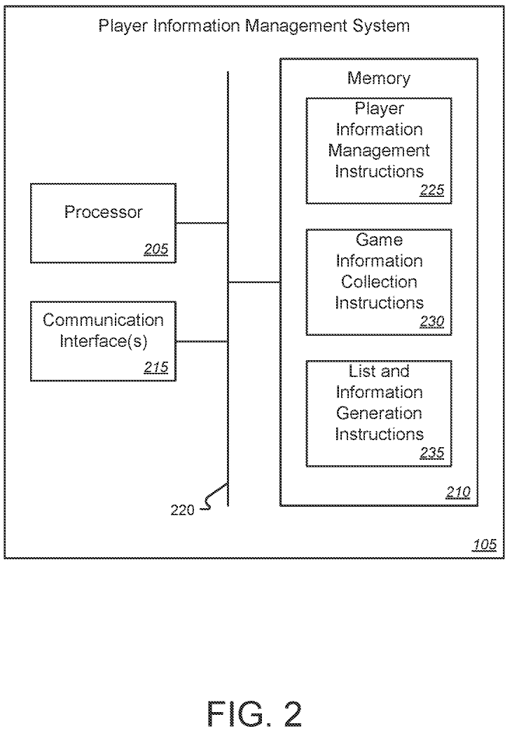

FIG. 2 is a block diagram illustrating additional details of an exemplary player information management system according to one embodiment of the present disclosure. As illustrated in this example, a player information management system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the player information management system 105 as described herein.

The memory 210 can be coupled with and readable by the processor 205 via a communications bus 220. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 215 via the communications bus 220. The communication interfaces 215 can comprise, for example, a Bluetooth, WiFi, cellular, and/or other type of wireless communications interface.

The memory 210 can store therein sets of instructions which, when executed by the processor 205, cause the processor 205 to manage player information as described herein. For example, the memory 210 can store a set of player information management instructions 225 which, when executed by the processor 205, can cause the processor 205 to maintaining 405 in a repository 115 a plurality of electronic files 110 for each of a plurality of players of a plurality of electronic games of the gaming venue as described above. As noted, each electronic record 140 in each of the plurality of electronic files 110 can be related to a different one of the plurality of electronic games and can comprise a plurality of fields. Each field 145 on the plurality of fields can relate to a different aspect of the related electronic game and can have a value based on past play of the related electronic game by the player. The games may be available on any one or more EGMs 125 and/or other gaming systems 135 as described above. The aspect of the game can include, but is not limited to a time duration of play of the game, a wager amount during play of the game, an indication of success during play of the game, etc.

The memory 210 can also have stored therein a set of game information collection instructions 230 which, when executed by the processor 205, causes the processor to receive an electronic message indicating initiation of play of a game, e.g., from the EGM 125 or gaming system 135. The game information collection instructions 230 can also cause the processor 205 to receive a value for the aspect of the game defined in the received information during individual play of the game by the player. In response, the player information management instructions 225 can cause the processor 205 to record a value for the aspect of the game defined in the received information in the field 145 related to the aspect of the game in the electronic record 140 associated with the game and in the file 110 for the player. In this way, the record 140 for the player and the game in the plurality of electronic files 110 can be updated based on game play by the player.

The memory 210 can also have stored therein a set of list and information generation instructions 235 which, when executed by the processor 205, causes the processor 205 to receive, from the mobile device 130 of the player, a request for information related to one or more games. In response, the list and information generation instructions 235 can cause the processor 205 to generate one or more rank-ordered lists 150 representing a leaderboard for the game or games based on the plurality of files 110. For example, the rank-ordered list 150 can be related to a particular aspect of a game, e.g., amount of time played, winnings, etc. In such cases, the rank-ordered list 150 can be ordered based on the value of a selected aspect of the plurality of aspects represented in a field 145 of the records 140 in the plurality of files 110, e.g., showing the players favorite or most winning games, in order. In other cases, the rank-ordered list 150 may comprise a list of other players ranked by the selected aspect. In any such case, the player information management system 105 can provide the generated rank-ordered list(s) 150 to the mobile device 130 of the player in response to the request for information related to the game.

In some cases, the list and information generation instructions 235 can cause the processor 205 to receive, from the mobile device 130 of the player, a request for additional information related to a game aspect represented in the provided rank-ordered list 150. In response, the list and information generation instructions 235 which, when executed by the processor 205, causes the processor 205 to provide, to the mobile device 130 of the player, the requested additional information. For example, the aspect may represent a game theme and the request for additional information can be initiated by a selection of a game theme of a rank-ordered list 150 of game themes provided to the player. In such cases, providing the additional information can comprise, for example, providing, to the mobile device 130 of the player, an indication of a location of a gaming machine in the gaming venue having the selected game theme. In other cases, the requested and provided additional information can relate to other aspects such as types of games, winningest games, longest played games, locations for such games, recommendations for other games, etc.

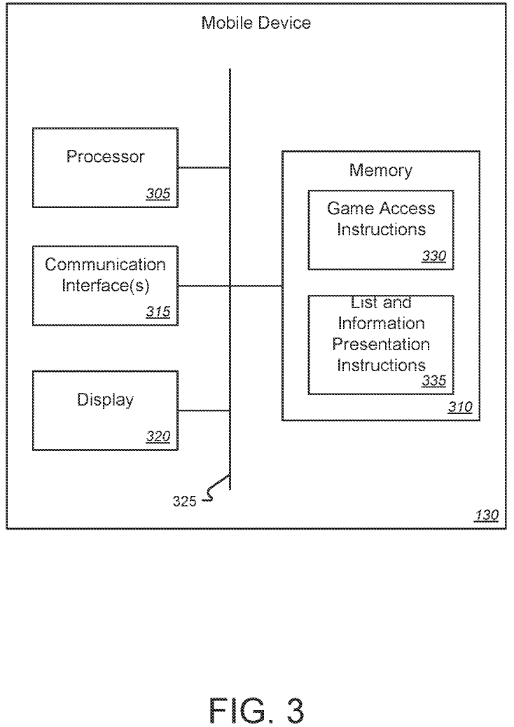

FIG. 3 is a block diagram illustrating additional details of an exemplary mobile device according to one embodiment of the present disclosure.

As illustrated in this example, the mobile device 130 can comprise a processor 305 such as any of the various types of processors described above. A memory 310 can be coupled with and readable by the processor 305 via a communications bus 325. The memory 310 can comprises any one or more of the different types of volatile and/or non-volatile memories described above. The processor 305 can also be coupled with one or more communication interfaces 315, and a display 320 via the communications bus 330. The communication interfaces 315 can comprise, for example, a cellular, Bluetooth, WiFi, and/or other type of wireless communications interface. The display 320 can comprise, for example, a Liquid Crystal Display (LCD), Light Emitting Diode (LED), Organic Light Emitting Diode (OLED), display or other type of display for presenting images and other graphics and can be touch sensitive allowing the user to use the display 320 as an input device as well.

The memory 310 can store therein sets of instructions which, when executed by the processor 305, cause the processor 305 to interact with the player information management system 105 to allow the user of the mobile device 115 to receive, view, and interact with rank-ordered lists 150 as described herein. More specifically, the memory 310 can store a set of game access instructions 330 that can, when executed by the processor 305, cause the processor 305 to access an electronic game of the gaming venue. For example, the game access instructions 330 can comprise a loyalty card app or mobile wallet app as known in the art installed on the mobile device 130 and accessing the game can comprise “carding in” to the game.

The memory 310 can also have stored therein a set of list and information presentation instructions 335 which, when executed by the processor 305, can cause the processor 305 to receive, through the communications interface 315, rank-ordered lists 150 from the player information management system 105 and present the received lists on the display 320. In some cases, the list and information presentation instructions can further cause the processor 305 to receive through a touch on the display 320 a selection, e.g., a selection of a game aspect or a different rank-ordered list 150. In response to the received selection, the list and information presentation instructions 335 can further cause the processor 305 to present the selected different rank-ordered lists 150. For example, the rank-ordered lists 150 can include a rank-ordered list 150 of players for a selected aspect of the electronic game, wherein the rank-ordered list 150 of players is ordered based on a value related to the selected aspect which in turn can be based on past play of the electronic game by each player of the plurality of different players, e.g., most winnings, longest playing, most wagered, etc. In another example, the selected rank-ordered list 150 can comprise a rank-ordered list 150 of game themes, e.g., the most popular game themes for the player. In response to receiving the selection of one of the game themes, the list and information presentation instructions 335 can cause the processor 305 to present on the display 320 an indication of a location of a gaming machine in the gaming venue having the selected game theme, e.g., a map of the gaming venue indicating the location, directions to the location, etc.

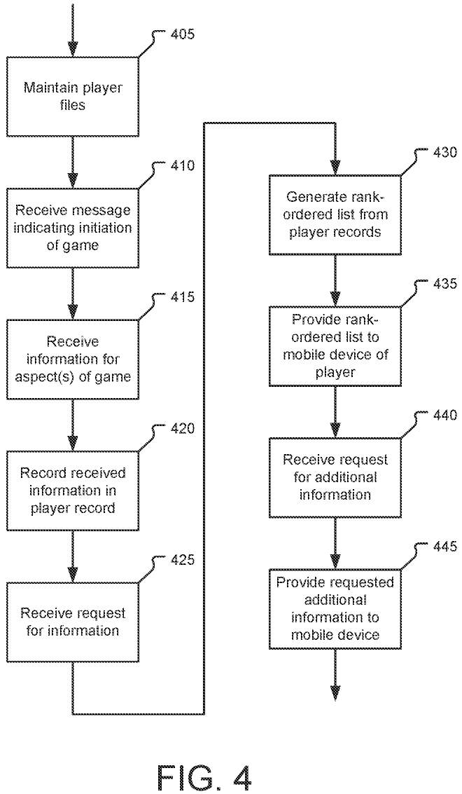

FIG. 4 is a flowchart illustrating an exemplary process for providing rank-ordered lists according to one embodiment of the present disclosure. More specifically, this example illustrates an exemplary process for generating and providing rank-ordered lists 150 as may be performed by the player information management system 105 described above. As illustrated in this example, the process can begin with maintaining 405, by the player information management system 405 of a gaming venue, a plurality of electronic files 110 for a plurality of players of electronic games of the gaming venue. The electronic file 110 for each player can comprise a plurality of electronic records 140. Each electronic record 140 of the plurality of electronic records 140 in the file 110 for each player can be related to a different one of the plurality of electronic games and can comprise a plurality of fields. Each field 145 on the plurality of fields can relate to a different aspect of the related electronic game and can have a value based on past play of the related electronic game by the player. The games may be available on any one or more EGMs 125 and/or other gaming systems 135 as described above. The aspect of the game can include, but is not limited to a time duration of play of the game, a wager amount during play of the game, an indication of success during play of the game, etc.

An electronic message indicating initiation of play of a game can be received 410 by the player information management system 105, e.g., from the EGM 125 or gaming system 135. Electronic information defining a value for the aspect of the game can also be received 415 by the player information management system 105 during individual play of the game by the player and a value for the aspect of the game defined in the received information can be recorded 420 in the field 145 related to the aspect of the game in the electronic record 140 associated with that game in the electronic file 110 for the player. In this way, the file 110 for the player and the record 140 for the game can be updated based on game play by the player.

At some point in time, the player information management system 105 of the gaming venue can receive 425, from the mobile device 130 of the player, a request for information related to one or more games. In response, the player information management system 105 can generate one or more rank-ordered lists 150 representing a leaderboard for the game or games based on the plurality of files 110. For example, the rank-ordered list 150 can be related to a particular aspect of a game, e.g., amount of time played, winnings, etc. In such cases, the rank-ordered list 150 can be ordered based on the value of a selected aspect of the plurality of aspects in the fields 145 in the electronic records 140 of the plurality of electronic files 110, e.g., showing the players favorite or most winning games, in order. In other cases, the rank-ordered list 150 may comprise a list of other players ranked by the selected aspect. In any such case, the player information management system 105 can provide the generated rank-ordered list(s) 150 to the mobile device 130 of the player in response to the request for information related to the game.

In some cases, the player information management system 105 can receive 440, from the mobile device 130 of the player, a request for additional information related to a game aspect represented in the provided rank-ordered list 150. In response, the player information management system 105 can provide, to the mobile device 130 of the player, the requested additional information. For example, the aspect may represent a game theme and the request for additional information can be initiated by a selection of a game theme of a rank-ordered list 150 of game themes provided to the player. In such cases, providing 445 the additional information can comprise, for example, providing, by the player information management system 110, to the mobile device 130 of the player an indication of a location of a gaming machine in the gaming venue having the selected game theme. In other cases, the requested and provided additional information can relate to other aspects such as types of games, winningest games, longest played games, locations for such games, recommendations for other games, etc.

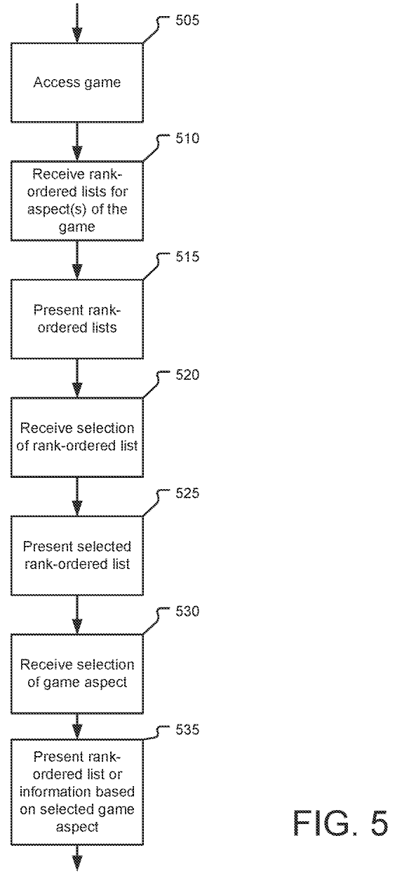

FIG. 5 is a flowchart illustrating an exemplary process for presenting rank-ordered lists according to one embodiment of the present disclosure. More specifically, this example illustrates an exemplary process as may be performed by a mobile device 130 of a player as described above. As illustrated in this example, the process can begin with accessing 505 an electronic game of the gaming venue. This can comprise “carding in” to the game through a loyalty card app or mobile wallet app installed on the mobile device 130 of the player and as known in the art.

In response to accessing the game or a request by the player, the mobile device 130 can receive 510, from the player information management system 105 of the gaming venue, one or more rank-ordered lists 150. Each rank-ordered list 150 can relate to a different aspect of the game and each rank-ordered list 150 can be ranked based on past play of the electronic game by the player. The mobile device 130 can present 515 an indication of each of the received rank-ordered lists 150, e.g., a list of the game aspects represented by the lists. A selection of one of the rank-ordered lists 150 can be received 520 by the mobile device 130, e.g., by the player touching or otherwise selecting one of the aspects represented. In response, the mobile device 130 can present 525 the selected rank-ordered list 150.

In some cases, the mobile device 130 can receive 530 a further selection, e.g., a selection of a game aspect or a different rank-ordered list 150. In response to the received 530 selection, the mobile device 130 can present 535 the selected different rank-ordered lists 150. For example, the rank-ordered lists 150 can include a rank-ordered list 150 of players for a selected aspect of the electronic game, wherein the rank-ordered list 150 of players is ordered based on a value related to the selected aspect which in turn can be based on past play of the electronic game by each player of the plurality of different players, e.g., most winnings, longest playing, most wagered, etc. In another example, the selected rank-ordered list 150 can comprise a rank-ordered list 150 of game themes, e.g., the most popular game themes for the player. In response to receiving the selection of one of the game themes, the mobile device 130 can present an indication of a location of a gaming machine in the gaming venue having the selected game theme, e.g., a map of the gaming venue indicating the location, directions to the location, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, microcode, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A player information management system of a gaming venue, the system comprising:
a repository storing an electronic file for a player, the electronic file comprising a plurality of electronic records, the plurality of electronic records comprising a record related to a game on an Electronic Gaming Machine (EGM) of the gaming venue, each record of the plurality of records comprising a field related to an aspect of the game on the EGM;
a processor communicatively coupled with the repository; and
a memory coupled with and readable by the processor and storing therein a set of instructions which, when executed by the processor, causes the processor to:
receive, from the EGM, an electronic message indicating initiation of play of a game on the EGM by a player;
receive, from the EGM, electronic information defining a value for the aspect of the game on the EGM during individual play of the game on the EGM by the player;
record the value for the aspect of the game on the EGM defined in the received information in the field related to the aspect of the game on the EGM in the electronic record associated with the game in electronic file for the player;
generate a rank-ordered list related to the aspect of the game on the EGM from the plurality of records and based on the field related to the aspect of the game in the electronic file for the player; and
provide the generated rank-ordered list to an electronic device associated with the player.

2. The player information management system of claim 1, wherein the electronic file for the player comprises one of a plurality of electronic files and wherein each file of the plurality of files is associated with a different player of the game on the EGM.

3. The player information management system of claim 1, wherein each of the plurality of electronic records in the electronic file for the player is associated with a different game available in the gaming venue.

4. The player information management system of claim 1, wherein the aspect of the game on the EGM comprises a time duration of play of the game on the EGM by the player.

5. The player information management system of claim 1, wherein the aspect of the game on the EGM comprises a wager amount during play of the game on the EGM by the player.

6. The player information management system of claim 1, wherein the aspect of the game on the EGM comprises an indication of success during play of the game on the EGM by the player.

7. The player information management system of claim 1, wherein the EGM comprises a slot machine.

8. A mobile device comprising:
a processor; and
a memory coupled with and readable by the processor and storing therein a set of instructions which, when executed by the processor, causes the processor to:
access an electronic game of the gaming venue, the electronic game having a plurality of aspects related to play of the electronic game;
receive, from a player information management system of the gaming venue, a plurality of rank-ordered lists, each rank-ordered list of the plurality of rank-ordered lists related to a different aspect of the plurality of aspects of the game, wherein each rank-ordered list is ranked based on past play of the electronic game by a user of the mobile device;
present, to the user of the mobile device, an indication of each of the received plurality of rank-ordered lists;
receive, from the user of the mobile device, a selection of a rank-ordered lists of the plurality of rank-ordered lists; and
present, to the user of the mobile device, the selected rank-ordered list of the plurality of rank-ordered lists.

9. The mobile device of claim 8, wherein the instructions further cause the processor to:
receive, from the user of the mobile device, a selection of a different rank-ordered list of the plurality of rank-ordered lists; and
in response to the received selection, present, to the user of the mobile device, the selected different rank-ordered lists.

10. The mobile device of claim 8, wherein the plurality of rank-ordered lists further comprises a rank-ordered list of a plurality of players for a selected aspect of the plurality of aspects related to play of the electronic game, wherein the rank-ordered list of the plurality of players is ordered based on a value related to the selected aspect, and wherein the value is based on past play of the electronic game by each player of the plurality of different players.

11. The mobile device of claim 10, wherein the instructions further cause the processor, in response to a selection of the selected aspect by the user of the mobile device, present the rank-ordered list of the plurality of players.

12. The mobile device of claim 8, wherein the selected rank-ordered list of the plurality of rank-ordered lists comprises a rank-ordered list of game themes.

13. The mobile device of claim 12, wherein the instructions further cause the processor, in response to receiving from the user of the mobile device a selection of a game theme of the rank-ordered list of game themes, present to the user of the mobile device an indication of a location of a gaming machine in the gaming venue having the selected game theme.

14. A method comprising:
maintaining, by a player information management system of a gaming venue, a plurality of electronic files, each electronic file of the plurality of electronic files associated with a player of a plurality of players of a plurality of electronic games of the gaming venue, each electronic file comprising a plurality of electronic records, each electronic record associated with an electronic game of the plurality of electronic games and comprising a plurality of fields, each field on the plurality of fields of each electronic record related to a different aspect of the electronic game associated with the electronic record and having a value based on past play of the related electronic game by the player associated with the electronic file;
receiving, by the player information management system of the gaming venue, from a mobile device of one of the plurality of players, a request for information related to the plurality of electronic games;
generating, by the player information management system of the gaming venue, a first rank-ordered list representing a leaderboard for the plurality of electronic games for one of the plurality of players and based on the plurality of electronic records of the electronic file associated with the one of the plurality of players, wherein the first rank-ordered list is ordered based on the value of a selected aspect of the plurality of aspects in the plurality of electronic records of the electronic file associated with the one of the plurality of players; and
providing, by the player information management system of the gaming venue, the generated first rank-ordered list to the mobile device of the one of the plurality of players in response to the request for information related to one of the plurality of electronic games.

15. The method of claim 14, further comprising:
generating, by the player information management system of the gaming venue, a second rank-ordered list representing a leaderboard of the plurality of players and based on the plurality of electronic files, wherein the second rank-ordered list is ordered based on the value of the selected aspect; and
providing, by the player information management system of the gaming venue, the generated second rank-ordered list to the mobile device of the one of the plurality of players.

16. The method of claim 14, wherein the aspect of the electronic game comprises a time duration of play of the electronic game by the one of the plurality of players.

17. The method of claim 14, wherein the aspect of the electronic game comprises a wager amount during play of the electronic game by the one of the plurality of players.

18. The method of claim 14, wherein the aspect of the electronic game comprises an indication of success during play of the electronic game by the one of the plurality of players.

19. The method of claim 14, wherein the second rank-ordered list of the plurality of rank-ordered lists comprises a rank-ordered list of game themes.

20. The method of claim 19, further comprising
receiving, by the player information management system of the gaming venue, from the mobile device of the one of the plurality of players, a selection of a game theme of the rank-ordered list of game themes; and
providing, by the player information management system of the gaming venue, to the mobile device of the one of the plurality of players an indication of a location of a gaming machine in the gaming venue having the selected game theme.
